(19) United States
(12) Patent Application Publication
(10) Pub. No.: US 2003/0235159 A1
(43) Pub. Date: Dec. 25, 2003

(54) Method for preventing interference between close-by remote devices

(76) Inventor: Robert Lin, Taipei Hsien (TW)

Correspondence Address: Robert Lin, Hsin Chuang, P.O. Box 4-67, Taipei, 242, TW

(21) Appl. No.: 10/178,320

(22) Filed: Jun. 21, 2002

(51) Int. Cl. G08C 19/00; H04B 7/204

(52) U.S. Cl. 370/319; 340/825.69

(57) ABSTRACT

A method for preventing an interference of a remote device by close-by remote devices includes a number of channels disposed in the remote device, and detecting and determining which of the channels have been used by the close-by remote devices, and which of the channels are unused. The remote device may then select either of the unused channels as a working channel, for preventing the signals or the beacons emitted by the unused working channel of the remote device from being interfered by those emitted from the close-by remote devices.

### BACKGROUND OF THE INVENTION

1. Field of the Invention

The present invention relates to a remote device, and more particularly to a method for selecting a working channel of a remote device that has not been used by the other close-by remote devices, or for preventing the interference between the close-by remote devices.

2. Description of the Prior Art

Typical remote devices, such as the typical remote control devices, the typical remote coupling devices, or the like, have been developed for receiving and/or for emitting the signals, in order to control or to operate the electric facilities, the computer facilities, the wireless network facilities, or the like.

However, when a number of remote control devices or remote coupling devices are located and used close to each other, the signals emitted from the remote control devices or the remote coupling devices may be interfered with each other, such that the remote control devices or the remote coupling devices may not be effectively used or operated.

The present invention has arisen to mitigate and/or obviate the afore-described disadvantages of the conventional remote devices.

### SUMMARY OF THE INVENTION

The primary objective of the present invention is to provide a method for selecting a working channel of a remote device that has not been used by the other close-by remote devices, and for preventing the signals emitted from the remote control devices or the remote coupling devices from being interfered with each other.

In accordance with one aspect of the invention, there is provided a method for preventing an interference of a first remote device by close-by remote devices, the method comprising providing the first remote device having a plurality of channels, detecting and determining which of the channels have been used by the close-by remote devices, and which of the channels are unused, and selecting either of the unused channels as a working channel. The signals or the beacons emitted from the first remote channel thus will not be interfered by those signals or beacons emitted from the other remote devices located or disposed close to the first remote device.

The beacons from the close-by remote devices may be obtained and received by the first remote device, in order to determine the number of the remote devices located close to the first remote device.

The beacons from the close-by remote devices may be scanned by the first remote device, in order to determine which of the channels have been used by the close-by remote devices.

The scanned beacons of the channels of the close-by remote devices may be compared with the channels of the first remote device, to determine which of the channels have been used by the close-by remote devices, and which of the channels are unused.

The first remote device may select a greatest channel as the working channel when a single channel has been used and when the single channel number is smaller than six.

Alternatively, the first remote device selects a smallest channel as the working channel when a single channel has been used and when the single channel number is greater than six.

Further alternatively, the first remote device may randomly select either of the unused channels as the working channel.

For example, the first remote device may select either intermediate channel of few unused consecutive channels as the working channel when the few unused consecutive channels have been detected and determined as the unused channels.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a schematic view illustrating the range of the emitted signals from one of two close-by remote devices;

FIG. 2 is a schematic view illustrating the ranges or the interfering between two close-by remote devices; and

FIG. 3 is a diagram illustrating the processes of a method in accordance with the present invention, for selecting a working channel that has not been used by the other close-by remote devices.

### DETAILED DESCRIPTION OF THE PREFERRED EMBODIMENT

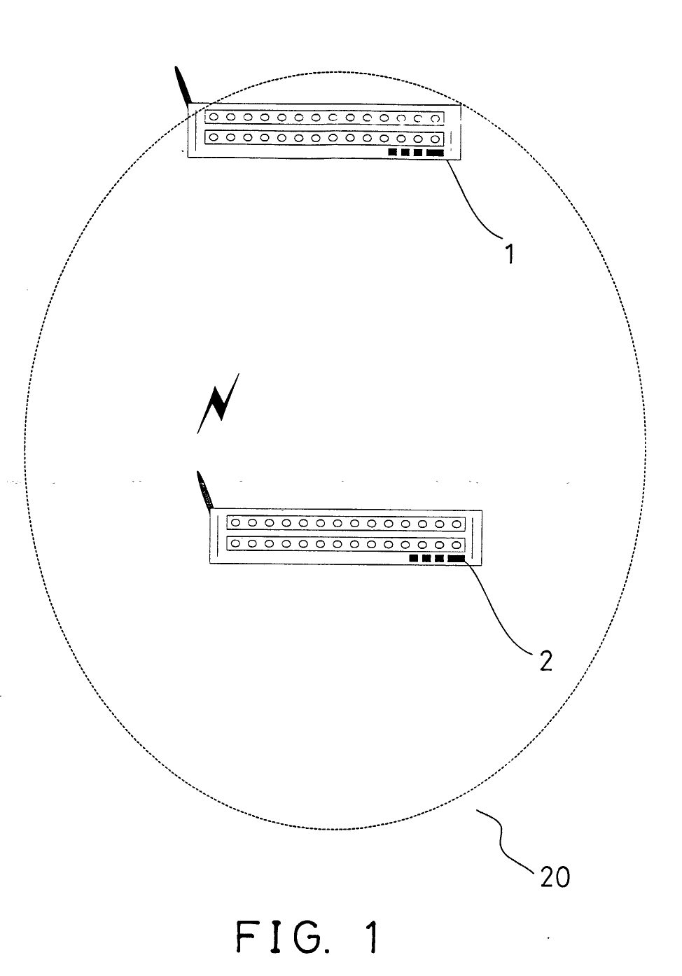

Referring to the drawings, and initially to FIG. 1, illustrated is the range 20 of the emitted signals or beacons from a remote device 2, such as a remote control device or a remote coupling device, and another remote device 1, also such as a remote control device or a remote coupling device, that is disposed between the range 20 of the emitted signals or beacons from the remote device 2.

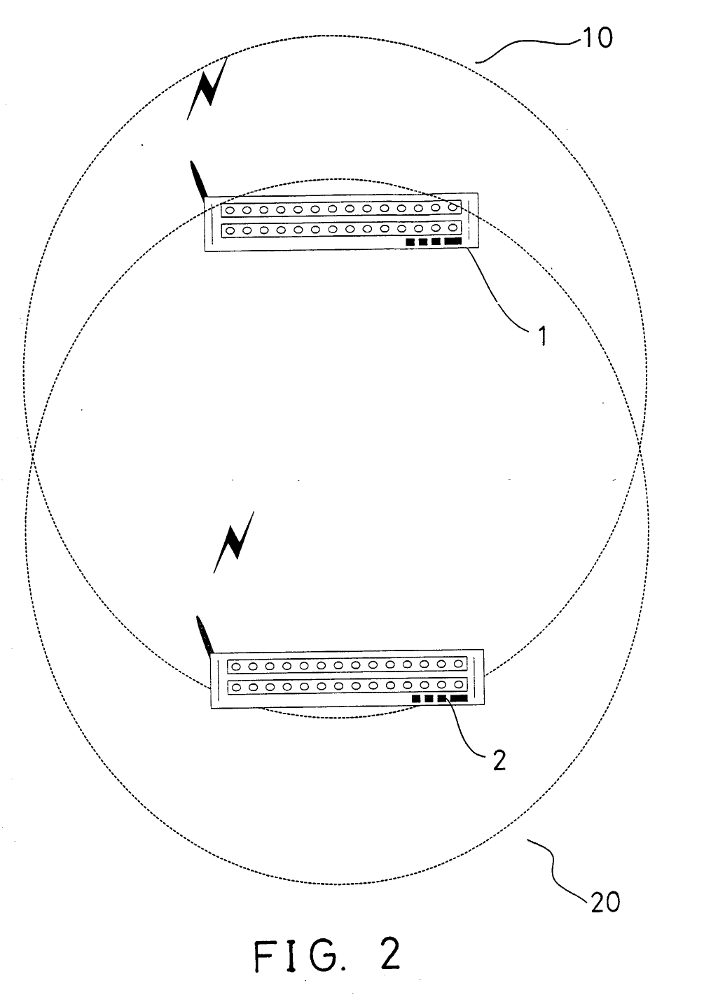

Referring next to FIG. 2, illustrated is the interference between the ranges 10, 20 of the emitted signals or beacons from the two close-by remote devices 1, 2, such that the signals or beacons emitted from the close-by remote devices 1, 2 may be interfered with each other.

A method in accordance with the present invention is provided for selecting a working channel of a remote device that has not been used by the other close-by remote devices, or for preventing the interference between the close-by remote devices.

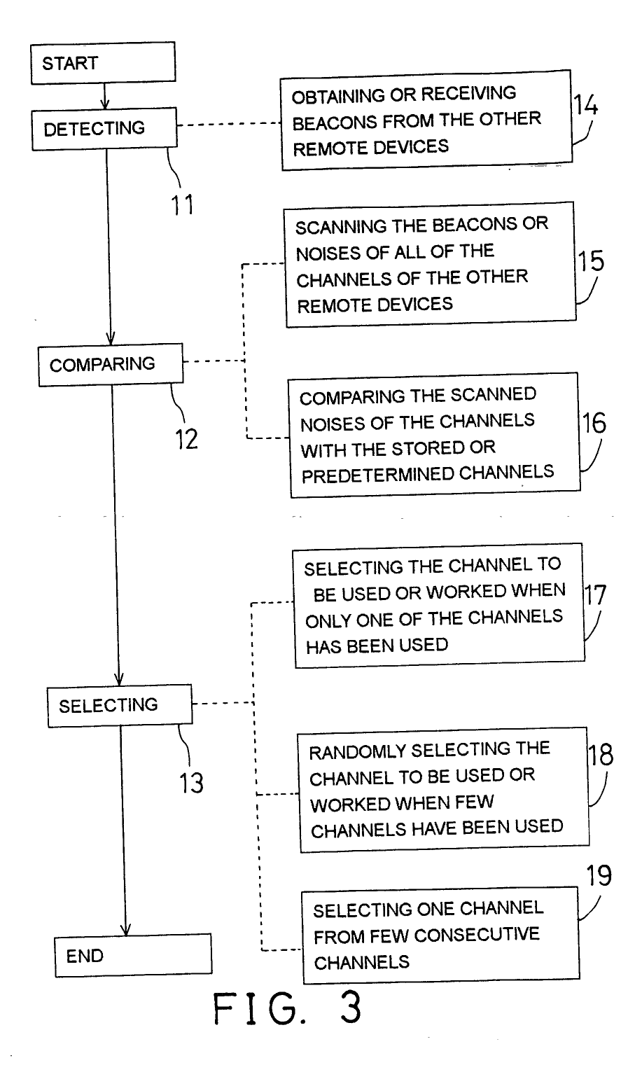

Referring next to FIG. 3, illustrated is an example for selecting a working channel of a remote device 1 that has not been used by the other close-by remote devices 2 (FIG. 2). Normally, the remote devices 1, 2 may include one or more, such as eleven or more channels that may be selectively used.

After started, the remote device 1, such as the typical control or processing unit (not shown) of the remote device 1 may first detect the signals or beacons emitted from the close-by remote devices 2, in the process 11, in order to obtain or to receive the beacons emitted from the other remote devices 2, in the process 14.

After the detecting process 11, the remote device 1 may obtain or receive the signals or the beacons emitted from the other remote devices 2 (process 14), and thus may detect or determine the numbers of the other remote devices 2 that are disposed or located close to the present remote device 1.

The remote device 1 may then compare the signals or the beacons or the noises from the other remote devices 2, in the process 12. For example, the remote device 1 may first scan the signals or the beacons or the noises from all of the channels of the other remote devices 2, in the process 15.

The remote device 1 may then compare the scanned and used channels of the other remote devices 2 with the channels of the present remote device 1, in the process 16, in order to check or to determine which channels have been used and which channels have not been used.

The remote device 1 may then select either one of the channels that has not been used by the other close-by remote devices 2, as the working channel, in the process 13, in order to prevent the signals emitted from the remote devices from being interfered with each other.

For example, in the process 17, when only one of the channels has been used by the other remote devices 2, and if the number of channel is greater than six (6), then the remote device 1 preferably select the greatest channel, such as channel eleven (11) as the working channel.

On the contrary, if the number of channel is smaller than six (6), then the remote device 1 preferably select the smallest channel, such as channel one (1) as the working channel.

In the process 18, when few channels, more than one but smaller than one half, i.e. six (6), have been used by the other remote devices 2, then the remote device 1 may randomly select either of the unused channel as the working channel.

For example, the remote device 1 may add the numbers of the smallest and the greatest channels, such as channels 1 and 11, that have not been used by the other remote devices 2, together, such as 1+11=12, and then divided by 2, i.e. 12/2=6, in order to determine and to select channel six (6) as the working channel.

Alternatively, in the process 19, when several consecutive channels have been found to be not used, for example, when three, five or seven (odd number) consecutive channels have not been used, the remote device 1 preferably select the middle or intermediate channel of the consecutive channels as the working channel.

For example, when channels 2, 3, 4, 5, 6 have not been used, the channel numbers 2 and 6 will be added together (2+6=8) and then divided by two (8/2=4), such that channel 4 will be selected as the working channel. when six consecutive channels have not been used, such as channels 5, 6, 7, 8, 9, 10, the channel numbers 5 and 10 will be added together (5+10=15) and then divided by two (15/2=7.5), such that either channel 7 or 8 will be selected as the working channel.

Similarly, when four consecutive channels have not been used, the remote device 1 may select either of the two middle or intermediate channels of the consecutive channels as the working channel. When two consecutive channels have not been used, the remote device 1 may select either of the two consecutive channels as the working channel.

In operation, the remote device 1 may first detect which of the channels have been used by the other remote devices, and may then select either of the unused channels as the working channel, for preventing the signals or the beacons emitted by the remote device 1-from being interfered by the other remote devices 2.

Accordingly, the method in accordance with the present invention may be used for selecting a working channel of a remote device that has not been used by the other close-by remote devices, and for preventing the signals emitted from the remote devices from being interfered with each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for preventing an interference of a first remote device by close-by remote devices, said method comprising:
providing the first remote device having a plurality of channels,
detecting and determining which of the channels have been used by the close-by remote devices, and which of the channels are unused, and
selecting either of the unused channels as a working channel.

2. The method according to claim 1 further comprising obtaining and receiving beacons from the close-by remote devices, to determine the number of the remote devices located close to said first remote device.

3. The method according to claim 1 further comprising scanning beacons from the close-by remote devices, to determine which of the channels have been used by the close-by remote devices.

4. The method according to claim 3 further comprising comparing the scanned beacons of the channels of the close-by remote devices with said channels of said first remote device, to determine which of the channels have been used by the close-by remote devices, and which of the channels are unused.

5. The method according to claim 1, wherein said first remote device selects a greatest channel as the working channel when a single channel has been used and when the single channel number is smaller than six.

6. The method according to claim 1, wherein said first remote device selects a smallest channel as the working channel when a single channel has been used and when the single channel number is greater than six.

7. The method according to claim 1, wherein said first remote device randomly selects either of said unused channels as the working channel.

8. The method according to claim 1, wherein said first remote device selects either intermediate channel of few unused consecutive channels as the working channel when the few unused consecutive channels have been detected and determined as the unused channels.
